(19) United States
(12) Patent Application Publication
(10) Pub. No.: US 2026/0185889 A1
(43) Pub. Date: Jul. 2, 2026

(54) POWER STORAGE DEVICE AND WATER ENTRY DETECTION METHOD

(71) Applicant: TOYOTA JIDOSHA KABUSHIKI KAISHA, Toyota-shi (JP)

(72) Inventor: Takeshi HONDA, Toyota-shi (JP)

(73) Assignee: TOYOTA JIDOSHA KABUSHIKI KAISHA, Toyota-shi (JP)

(21) Appl. No.: 19/321,638

(22) Filed: Sep. 8, 2025

(30) Foreign Application Priority Data
Dec. 26, 2024 (JP) 2024-231080

(51) Int. Cl. G01M 3/16; H01M 50/24; G08B 21/20

(52) U.S. Cl. CPC G01M 3/165; H01M 50/24; G08B 21/20

(57) ABSTRACT

A power storage device includes: a battery pack; a lower case having a groove receding downward of a lower end of the battery pack and provided outward of a placement surface on which the battery pack is placed directly or indirectly; a first detection line including a first exposed conductive portion disposed inside the groove; a second detection line including a second exposed conductive portion disposed inside the groove at a predetermined distance from the first exposed conductive portion; and an electronic device to which the first and second detection lines are connected, and that measures a resistance or potential difference between the first and second detection lines. A water entry detection method includes: measuring the resistance or potential difference between the first and second detection lines; and estimating that water entry has occurred when the measured resistance or potential difference is equal to or less than a predetermined value.

### CROSS-REFERENCE TO RELATED APPLICATION

This application claims priority to Japanese Patent Application No. 2024-231080 filed on December 26, 2024. The disclosure of the above-identified application, including the specification, drawings, and claims, is incorporated by reference herein in its entirety.

### BACKGROUND

### 1. Technical Field

The present disclosure relates to a power storage device and a water entry detection method.

### 2. Description of Related Art

Japanese Unexamined Patent Application Publication No. 2009-231060 (JP 2009-231060 A) discloses a battery pack in which a conduction detection electrode for detecting water entry is disposed on the upper surface of a secondary battery via an insulating sheet and a conductive sheet for detecting swelling of the secondary battery is disposed at a distance above the conduction detection electrode for detecting water entry.

### SUMMARY

In the battery pack described in JP 2009-231060 A, the conduction detection electrode for detecting water entry is disposed on the upper surface of the secondary battery. Therefore, the secondary battery may be heavily wetted when the conduction detection electrode detects water entry.

In view of the above issue, the present disclosure relates to providing a power storage device and a water entry detection method in which water entry can be detected before a battery pack is wetted.

A power storage device according to claim 1 includes a battery pack, a lower case, a first detection line, a second detection line, and an electronic device. The lower case includes a placement surface on which the battery pack is placed directly or indirectly, and has a groove provided outward of the placement surface and receding downward of a lower end of the battery pack. The first detection line includes a first exposed conductive portion in which a conductive portion is exposed. The first exposed conductive portion is disposed inside the groove. The second detection line includes a second exposed conductive portion in which a conductive portion is exposed. The second exposed conductive portion is disposed inside the groove at a predetermined distance from the first exposed conductive portion. The first detection line and the second detection line are connected to the electronic device. The electronic device is configured to measure a resistance or a potential difference between the first detection line and the second detection line.

In the power storage device according to claim 1, the first exposed conductive portion and the second exposed conductive portion are disposed inside the groove receding downward of the lower end of the battery pack. Therefore, when water that has entered is accumulated in the groove, water entry is detected. Thus, the water entry can be detected before the battery pack is wetted.

In claim 1, a power storage device according to claim 2 further includes an upper case that houses the battery pack in cooperation with the lower case. The lower case includes a first flange portion. The upper case includes a second flange portion that mates with the first flange portion. The groove is provided in the first flange portion.

In the power storage device according to claim 2, when water enters through the space between the first flange portion and the second flange portion, the water entry can be detected before the battery pack is wetted.

In a power storage device according to claim 3, in claim 1 or 2, the groove is provided along an entire periphery outward of the placement surface. The first detection line and the second detection line are each disposed along an entire periphery of the groove. A plurality of the first exposed conductive portions and a plurality of the second exposed conductive portions are provided.

In the power storage device according to claim 3, water entry can be detected at a plurality of locations around the placement surface. Thus, oversight of water entry detection can be suppressed.

In a power storage device according to claim 4, in any one of claims 1 to 3, both the first exposed conductive portion and the second exposed conductive portion are disposed at a lower part inside the groove. The lower part inside the groove typically means a part below the middle of the depth of the groove.

In the power storage device according to claim 4, the period from the time when water entry into the lower case is detected to the time when the water reaches the placement surface can be delayed compared to the case where at least one of the first exposed conductive portion and the second exposed conductive portion is disposed at the upper part inside the groove.

A water entry detection method according to claim 5 includes measuring a resistance or a potential difference between a first detection line and a second detection line, and estimating that water entry has occurred inside a groove when the measured resistance or the measured potential difference is equal to or less than a predetermined value. The first detection line includes a first exposed conductive portion in which a conductive portion is exposed. The second detection line includes a second exposed conductive portion in which a conductive portion is exposed. The first exposed conductive portion is disposed inside the groove receding downward of a lower end of a battery pack and provided outward of a placement surface of a lower case on which the battery pack is placed directly or indirectly. The second exposed conductive portion is disposed inside the groove at a predetermined distance from the first exposed conductive portion.

In the water entry detection method according to claim 5, water entry is detected when the first exposed conductive portion and the second exposed conductive portion disposed inside the groove receding downward of the lower end of the battery pack are conductive via the water that has entered. Thus, the water entry can be detected before the battery pack is wetted.

According to the present disclosure, water entry can be detected before the battery pack is wetted.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an exploded perspective view of a power storage device according to a first embodiment of the present disclosure;

FIG. 2 is a sectional view taken along line II-II and seen along arrows in FIG. 1;

FIG. 3 is a circuit diagram of an ECU of the power storage device according to the first embodiment of the present disclosure; and

FIG. 4 is a flowchart illustrating the procedure of a water entry detection method according to a second embodiment of the present disclosure.

### DETAILED DESCRIPTION OF EMBODIMENTS

Hereinafter, embodiments of the present disclosure will be described with reference to the drawings. Identical or corresponding components in the drawings are denoted by the same or similar signs, and redundant descriptions will be omitted. The dimensions and ratios of the drawings are exaggerated for the convenience of description and may differ from actual ratios.

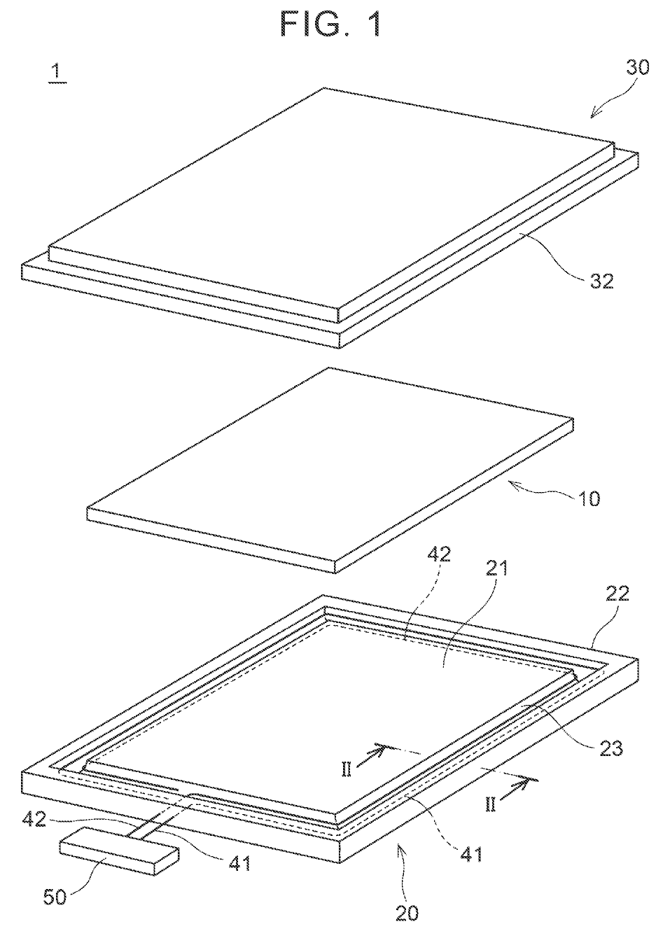

First, a power storage device 1 according to a first embodiment of the present disclosure will be described with reference to FIG. 1. FIG. 1 is an exploded perspective view of the power storage device 1. The power storage device 1 includes a battery pack 10, a lower case 20, an upper case 30, a first detection line 41, a second detection line 42, and an ECU 50.

The battery pack 10 typically includes a plurality of power storage cells. The power storage cell may be a secondary battery such as a lithium ion battery or a nickel metal hydride battery. The power storage cell may be a cell using a liquid electrolyte or a cell using a solid electrolyte. In the present embodiment, the battery pack 10 formed by integrating the power storage cells has an external appearance of a rectangular plate. The battery pack 10 may be connected to power storage equipment (not shown) via a conductive member.

The lower case 20 defines a space that houses the battery pack 10 in cooperation with the upper case 30. The lower case 20 is a container disposed below the battery pack 10. The lower case 20 is typically made of a steel plate etc., but may be made of a material other than the steel plate depending on the application of the power storage device 1, etc.

The lower case 20 includes a placement surface 21 on which the battery pack 10 is placed. The placement surface 21 is typically large enough to contain the battery pack 10. In the present embodiment, the placement surface 21 has a rectangular shape with the same size as that of the planar shape of the battery pack 10, but the size may be larger than that of the planar shape of the battery pack 10. The placement surface 21 is typically flat, but may have protrusions that support the battery pack 10 at a plurality of points or lines. The battery pack 10 is typically placed directly on the placement surface 21, but may be placed indirectly via another member such as a waterproof sheet. The placement surface 21 may be provided with a positioning tab (not shown) for determining the planar position of the placed battery pack 10.

In the present embodiment, the lower case 20 includes a lower flange 22 on the outer periphery. The lower flange 22 corresponds to a first flange portion. The lower flange 22 is provided along the entire periphery outward of the placement surface 21. The lower flange 22 has a groove 23. The groove 23 recedes downward of the lower end (i.e., the lowermost portion) of the battery pack 10 placed on the placement surface 21. In the present embodiment, the groove 23 is formed along the entire periphery outward of the placement surface 21. In the present embodiment, the groove 23 is formed in the lower flange 22 at the boundary with the placement surface 21, but may be formed in the lower flange 22 at a portion spaced outwardly away from the boundary with the placement surface 21.

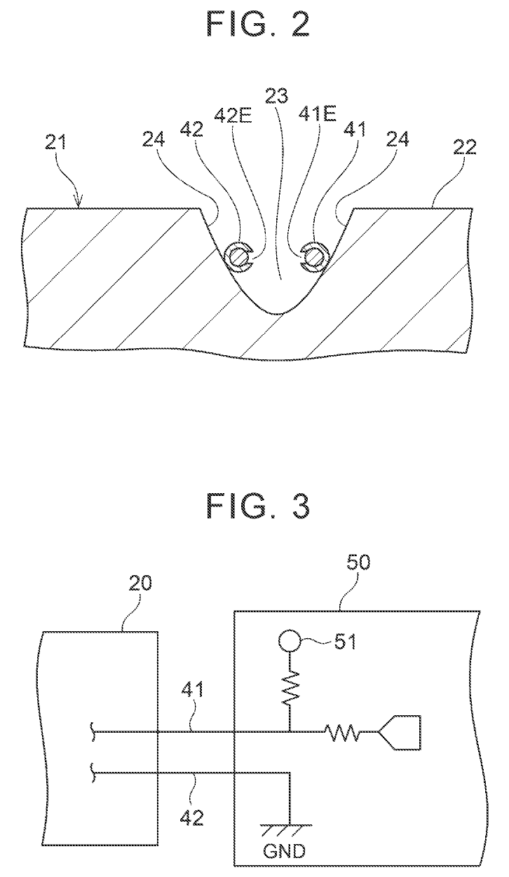

FIG. 2 illustrates a sectional shape of the groove 23. FIG. 2 is a sectional view taken along line II-II and seen along arrows in FIG. 1. The top and bottom of the drawing sheet of FIG. 2 correspond to the actual top and bottom. In the present embodiment, the width of the groove 23 decreases as it extends downward and the lower end is curved, but this shape is not limitative. For example, the groove 23 may have a shape in which the width does not change as it extends downward and the lower end is flat. The groove 23 includes a pair of wall surfaces 24 facing each other on the inner side and the outer periphery side of the lower case 20. In the present embodiment, the wall surfaces 24 are inclined such that the distance therebetween decreases as they extend downward. In the following description, reference will be made to FIG. 2 as appropriate when the groove 23 is mentioned.

The upper case 30 defines the space that houses the battery pack 10 in cooperation with the lower case 20. The upper case 30 is a container disposed above the battery pack 10. Similarly to the lower case 20, the upper case 30 is typically made of a steel plate etc., but may be made of a material other than the steel plate depending on the application of the power storage device 1, etc. In the present embodiment, the upper case 30 includes an upper flange 32 on the outer periphery. The upper flange 32 is a portion that mates with the lower flange 22, and corresponds to a second flange portion. When the lower flange 22 and the upper flange 32 are butted against each other while facing each other over the entire periphery, the space that can house the battery pack 10 is defined between the lower case 20 and the upper case 30.

The first detection line 41 is provided to detect entry of water into the groove 23 in cooperation with the second detection line 42. The first detection line 41 includes a portion disposed inside the groove 23. In the present embodiment, the first detection line 41 includes a portion disposed along the entire periphery of the groove 23 that is formed along the entire periphery outward of the placement surface 21. In the present embodiment, the portion of the first detection line 41 disposed inside the groove 23 is attached to one wall surface 24 at the lower part of the groove 23 as shown in FIG. 2. The lower part of the groove 23 means a part at a height smaller than half the depth of the groove 23. In the present embodiment, the first detection line 41 is disposed at a position that is 1/2 to 2/3 of the depth of the groove 23 downward of the upper surface of the lower flange 22. The first detection line 41 typically has a basic configuration in which an insulator such as rubber is provided as a coating on an exposed electric wire. The exposed electric wire of the first detection line 41 serves as a conductive portion through which a current flows.

The first detection line 41 includes a first exposed portion 41E at the portion disposed inside the groove 23. The first exposed portion 41E is a portion where the electric wire is exposed by forming a detection hole in the insulator covering the exposed electric wire, and corresponds to a first exposed conductive portion. In the present embodiment, a plurality of first exposed portions 41E is formed at predetermined intervals in the direction in which the groove 23 extends along the outer periphery of the placement surface 21 (hereinafter referred to as "circumferential direction" of the groove 23). The predetermined intervals of the first exposed portions 41E may be determined from the viewpoint that entry of water into any location in the groove 23 can be detected as quickly as possible. The first exposed portions 41E are typically formed at regular intervals (i.e., equal intervals), but the distance between adjacent first exposed portions 41E may vary depending on the location. Each first exposed portion 41E may have such a size that, when water is present outside the first detection line 41, the water can reach the electric wire covered with the insulator.

The second detection line 42 is provided to detect entry of water into the groove 23 in cooperation with the first detection line 41. The second detection line 42 typically has the same structure as that of the first detection line 41, and an exposed electric wire is typically covered with an insulator. Similarly to the first detection line 41, the second detection line 42 includes a portion disposed inside the groove 23. In the present embodiment, the second detection line 42 includes a portion disposed along the entire periphery of the groove 23 that is formed along the entire periphery outward of the placement surface 21. In the present embodiment, the portion of the second detection line 42 disposed inside the groove 23 is attached, at the lower part of the groove 23, to the wall surface 24 facing the wall surface 24 to which the first detection line 41 is attached. The second detection line 42 is typically disposed at the same height as that of the first detection line 41, but may be disposed at a different height from that of the first detection line 41.

The second detection line 42 includes a second exposed portion 42E at the portion disposed inside the groove 23. The second exposed portion 42E is a portion where the electric wire is exposed by forming a detection hole in the insulator covering the exposed electric wire, and corresponds to a second exposed conductive portion. The second exposed portion 42E exhibits the same function as that of the first exposed portion 41E of the first detection line 41, and a plurality of second exposed portions 42E is formed with the same configuration as that of the first exposed portions 41E. The second exposed portions 42E are preferably disposed as close to the first exposed portions 41E as possible, for example, such that their circumferential positions in the groove 23 are aligned.

Portions of the first detection line 41 and the second detection line 42 that are not disposed in the groove 23 extend outside the lower case 20 and are connected to the ECU 50. The first detection line 41 and the second detection line 42 may be connected to power storage equipment (not shown). In the first detection line 41 and the second detection line 42, the portions other than the portions disposed inside the groove 23, that is, the portions that extend outside the groove 23 and are connected to the ECU 50 or the power storage equipment (not shown), are entirely covered with the insulators, and have no wire-exposed portion.

The electronic control unit (ECU) 50 is a device that performs control using an electronic circuit, and corresponds to an electronic device. The first detection line 41 and the second detection line 42 are connected to the ECU 50. The ECU 50 measures the resistance or potential difference between the first detection line 41 and the second detection line 42. The ECU 50 estimates that water has entered the power storage device 1 when the measured resistance or potential difference is equal to or less than a predetermined value. The predetermined value is a potential difference with a high probability that the first detection line 41 and the second detection line 42 are conductive. For example, the predetermined value is a value close to zero or a value corresponding to the resistance of water. When it is estimated that water has entered the power storage device 1, the ECU 50 may notify a user, for example, by transmitting a signal. Examples of the notification for the user include transmission of an alert signal to a higher-level control panel (not shown), sending of an email with details of notification to the user via a network, and emission of alert sound or light.

FIG. 3 illustrates an electronic circuit inside the ECU 50. The first detection line 41 is connected to a power supply 51 inside the ECU 50. The second detection line 42 is connected to a ground. When the first detection line 41 and the second detection line 42 are insulated from each other, the potential of the first detection line 41 is the potential of the power supply 51. When the first detection line 41 and the second detection line 42 are conductive, the potential of the first detection line 41 is the ground potential. The first detection line 41 and the second detection line 42 are conductive, for example, when water accumulated in the groove 23 comes into contact with the first exposed portion 41E and the second exposed portion 42E and the first detection line 41 and the second detection line 42 come into contact with each other via the water accumulated in the groove 23. Thus, it is possible to detect entry of water such as rainwater or coolant in which an electrolyte is dissolved to cause a current flow.

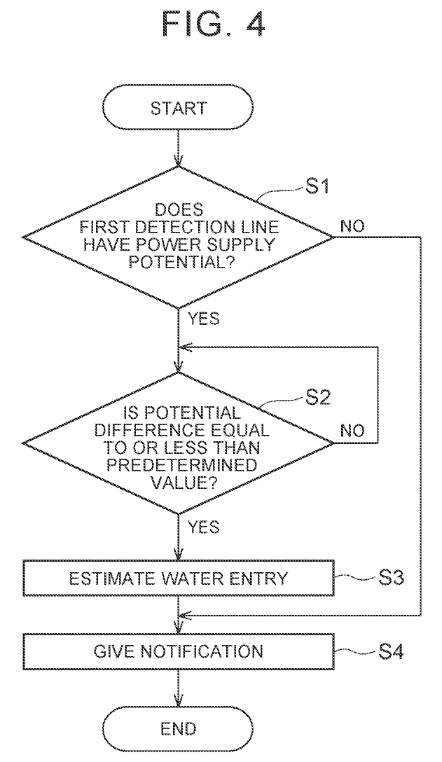

Next, a water entry detection method according to a second embodiment of the present disclosure will be described with reference to FIG. 4. FIG. 4 is a flowchart illustrating the procedure of the water entry detection method. The following description will be given of the water entry detection method for the power storage device 1, and serves also as description of functions of the power storage device 1. In the following description, reference will be made to FIGS. 1 to 3 as appropriate when the configuration of the power storage device 1 is mentioned. The water entry detection method according to the second embodiment of the present disclosure can be applied to cases other than the power storage device 1.

When water entry detection is started, the ECU 50 determines whether the potential of the first detection line 41 is the potential of the power supply 51 (S1). When no water enters the power storage device 1 and no water enters the groove 23, the first detection line 41 and the second detection line 42 are normally not conductive via the first exposed portion 41E and the second exposed portion 42E, and the potential of the first detection line 41 is the potential of the power supply 51. In the present embodiment, the potential difference between the first detection line 41 and the second detection line 42 is the potential of the power supply 51.

When the potential of the first detection line 41 is the potential of the power supply 51 in step S1 (YES in step S1), the ECU 50 determines whether the potential difference between the first detection line 41 and the second detection line 42 is equal to or less than the predetermined value (S2). When no water enters the groove 23, the potential difference normally exceeds the predetermined value. When the potential difference is not equal to or less than the predetermined value (NO in step S2), the process returns to step S2.

When water enters the power storage device 1 in step S2, the water enters the lower portion of the lower case 20, that is, the groove 23. Since the groove 23 is formed outward of the placement surface 21, the water that has entered the power storage device 1 enters the groove 23 before reaching the battery pack 10. When water enters the groove 23, the water level rises inside the groove 23, and the water in the groove 23 comes into contact with the first exposed portion 41E and the second exposed portion 42E, the first detection line 41 and the second detection line 42 are conductive via the water in the groove 23. When the first detection line 41 and the second detection line 42 are conductive, the potential difference between the first detection line 41 and the second detection line 42 decreases. When the potential difference between the first detection line 41 and the second detection line 42 is equal to or less than the predetermined value (YES in step S2), the ECU 50 estimates that water has entered the power storage device 1, that is, water entry has occurred (S3).

In the present embodiment, the ECU 50 notifies the user when the ECU 50 estimates that water entry has occurred (S4). The user who receives the notification can prevent the water from coming into contact with the battery pack 10 by, for example, inspecting the target power storage device 1. In the present embodiment, the groove 23 is formed along the entire periphery outward of the placement surface 21. Therefore, the amount of water to be held in the groove 23 can be increased compared to the case where the groove 23 is formed partially. Since the first exposed portion 41E and the second exposed portion 42E are disposed at the lower part inside the groove 23, a time difference can be secured between the time when the ECU 50 detects a change in potential difference and the time when the water accumulated in the groove 23 overflows. Thus, the user can have time to inspect the power storage device 1 after receiving the notification. In the present embodiment, the ECU 50 notifies the user (S4) also when the potential of the first detection line 41 is not the potential of the power supply 51 in step S1 (NO in step S1).

As described above, with the power storage device 1 according to the first embodiment and the water entry detection method according to the second embodiment, water entry can be detected before water comes into contact with the battery pack 10.

In the above description, the lower case 20 includes the lower flange 22 and the upper case 30 includes the upper flange 32, but the lower flange 22 and the upper flange 32 need not be provided. In this case, the lower case 20 and the upper case 30 may have a known fitting structure. When the lower flange 22 is not provided, the groove 23 may be formed outward of the placement surface 21 and inward of the outer edge of the lower case 20.

In the above description, the groove 23 is formed along the entire periphery of the placement surface 21, but may be formed partially on the periphery of the placement surface 21. When a plurality of grooves 23 is formed partially on the periphery of the placement surface 21, the first exposed portions 41E and the second exposed portions 42E may be disposed in all or part of the grooves 23.

In the above description, the first detection line 41 and the second detection line 42 are installed along the entire periphery of the groove 23 that is formed along the entire periphery of the placement surface 21, the first detection line 41 includes the first exposed portions 41E provided at the predetermined intervals, and the second detection line 42 includes the second exposed portions 42E provided at the predetermined intervals. However, the entire portion of the first detection line 41 and/or the entire portion of the second detection line 42 disposed inside the groove 23 may be free of the insulator and the electric wire may be exposed.

In the above description, the first exposed portion 41E and the second exposed portion 42E are disposed at the lower part of the groove 23, but at least one of them may be disposed at the upper part inside the groove 23. The upper part of the groove 23 means a part at a height larger than half the depth of the groove 23, and may be a position that is 1/3 to 1/2 of the depth of the groove 23 downward of the upper surface of the lower flange 22. In this case, it is possible to reduce the probability that the first exposed portion 41E and the second exposed portion 42E come into contact with a conductive substance that accidentally enters the groove 23, thereby suppressing erroneous water entry detection.

In the above description, in the water entry detection method, it is estimated that water entry has occurred inside the power storage device 1 when the potential difference between the first detection line 41 and the second detection line 42 is equal to or less than the predetermined value. Alternatively, it may be estimated that water entry has occurred inside the power storage device 1 when the resistance between the first detection line 41 and the second detection line 42 is equal to or less than the predetermined value.

What is claimed is:

1. A power storage device comprising:
a battery pack;
a lower case including a placement surface on which the battery pack is placed directly or indirectly, and having a groove provided outward of the placement surface and receding downward of a lower end of the battery pack;
a first detection line including a first exposed conductive portion in which a conductive portion is exposed, the first exposed conductive portion being disposed inside the groove;
a second detection line including a second exposed conductive portion in which a conductive portion is exposed, the second exposed conductive portion being disposed inside the groove at a predetermined distance from the first exposed conductive portion; and
an electronic device to which the first detection line and the second detection line are connected, the electronic device being configured to measure a resistance or a potential difference between the first detection line and the second detection line.

2. The power storage device according to claim 1, further comprising an upper case that houses the battery pack in cooperation with the lower case, wherein:
the lower case includes a first flange portion;
the upper case includes a second flange portion that mates with the first flange portion; and
the groove is provided in the first flange portion.

3. The power storage device according to claim 1, wherein:
the groove is provided along an entire periphery outward of the placement surface;
the first detection line and the second detection line are each disposed along an entire periphery of the groove; and
a plurality of the first exposed conductive portions and a plurality of the second exposed conductive portions are provided.

4. The power storage device according to claim 1, wherein both the first exposed conductive portion and the second exposed conductive portion are disposed at a lower part inside the groove.

5. A water entry detection method comprising:
measuring a resistance or a potential difference between a first detection line and a second detection line, the first detection line including a first exposed conductive portion in which a conductive portion is exposed, the second detection line including a second exposed conductive portion in which a conductive portion is exposed, the first exposed conductive portion being disposed inside a groove receding downward of a lower end of a battery pack and provided outward of a placement surface of a lower case on which the battery pack is placed directly or indirectly, the second exposed conductive portion being disposed inside the groove at a predetermined distance from the first exposed conductive portion; and
estimating that water entry has occurred inside the groove when the measured resistance or the measured potential difference is equal to or less than a predetermined value.
